(19) United States
(12) Patent Application Publication
(10) Pub. No.: US 2013/0314204 A1
(43) Pub. Date: Nov. 28, 2013

(54) PORTABLE ELECTRONIC DEVICE AND METHOD OF UNLOCKING THEREOF

(71) Applicants: HON HAI PRECISION INDUSTRY CO., LTD., New Taipei (TW); HONG FU JIN PRECISION INDUSTRY (Shenzhen) CO., LTD., Shenzhen (CN)

(72) Inventors: TEN-CHEN HO, New Taipei (TW); XIAO-LIAN HE, Shenzhen (CN)

(73) Assignees: HON HAI PRECISION INDUSTRY CO., LTD., New Taipei (TW); HONG FU JIN PRECISION INDUSTRY (Shenzhen) CO., LTD., Shenzhen (CN)

(21) Appl. No.: 13/898,497

(22) Filed: May 21, 2013

(30) Foreign Application Priority Data
May 25, 2012 (CN) 2012101652817

(51) Int. Cl. G05B 1/00

(52) U.S. Cl. CPC G05B 1/00
USPC 340/5.2

(57) ABSTRACT

A method executes a gyroscope function to set unlock method for a portable electronic device. A user can rotate the portable electronic device to set a predetermined rotation direction and a predetermined rotation angle for unlocking the portable electronic device. In an unlock method setting procedure, the gyroscope detects the rotated portable electronic device and outputs detected information of the portable electronic device. An unlock method of the portable electronic device is set according to the detected information.

### BACKGROUND

1. Technical Field

Embodiments of the present disclosure relate to unlocking methods of an electronic device, and particularly to a method of unlocking a portable electronic device.

2. Description of Related Art

Many portable electronic devices (mobile phone, tablet personal computer, for example) use touch screens. A touch screen can easily be activated by accident, thus a screen lock is often adopted to avoid unintentional operations. Usually, a user has to perform a slide operation on the touch screen to unlock the portable electronic device. However, repeated slide operations may damage the touch screen.

### BRIEF DESCRIPTION OF THE DRAWINGS

Many aspects of the present disclosure can be better understood with reference to the following drawing. The components in the drawing are not necessarily drawn to scale, the emphasis instead being placed upon clearly illustrating the principles of the disclosure.

FIG. 1 is a block diagram of one embodiment of a portable electronic device comprising an unlocking system.

FIG. 2 is a block diagram of one embodiment of function modules of the unlocking system in FIG. 1.

FIG. 3 is a flowchart illustrating one embodiment of a method for setting unlock method of a portable electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or Assembly. One or more software instructions in the module may be embedded in firmware, such as an EPROM. It will be appreciated that module may comprise connected logic units, such as gates and flip-flops, and may comprise programmable units, such as programmable gate arrays or processors. The module described herein may be implemented as either software and/or hardware module and may be stored in any type of computer-readable medium or other computer storage device.

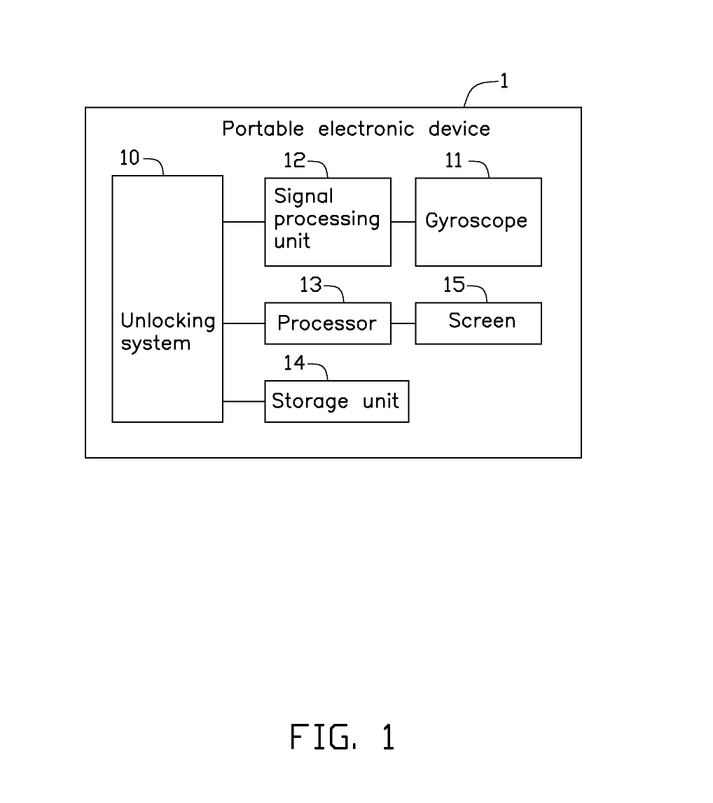

FIG. 1 is a block diagram of one embodiment of a portable electronic device 1 comprising an unlocking system 10. Depending on the embodiment, the portable electronic device 1 can be a mobile phone, a personal digital assistant (PDA), a handheld game console, a digital camera (DC), or a handheld computer. The portable electronic device 1 further comprises a gyroscope 11, a signal processing unit 12, a processor 13, a storage unit 14, and a screen 15. The portable electronic device 1 operates under an lock mode, a work mode, and a unlock mode. In the lock mode, the screen 15 is locked, and the portable electronic device 1 cannot be operated by touching the screen 15. In the work mode, the screen 15 is unlocked, and the portable electronic device 1 can be operated by touching the screen 15. In the unlock mode, the portable electronic device 1 can be rotated to set an unlock method for the portable electronic device 1. The unlock method for unlocking the screen 15 of the electronic device can comprise a rotation direction and a rotation angle of the portable electronic device 1.

The gyroscope 11 detects an angular rotation of the portable electronic device 1 (e.g., when the portable electronic device is rotating or moving in a user's hand) when the portable electronic device 1 is in the unlock mode or the lock mode. The signal processing unit 12 converts the detected angular rotation into a rotation direction and a rotation angle and generates a movement curve of the portable electronic device 1 according to the rotation direction and the rotation angle. The movement curve defines a curve, shown on the screen 15, representing movement of the portable electronic device 1. The processor 13 controls the converted rotation direction, the converted rotation angle, and the movement curve to be displayed on the screen 15 to inform a user. According to displayed information on the screen 15, the user can unlock the screen 15 of the portable electronic device 1 by adjusting the rotation direction and the rotation angle of the portable electronic device 1 to match an unlocking condition. The storage unit 14 stores a predetermined rotation direction and a predetermined rotation angle to unlock the screen 15 (i.e. the rotation direction and the rotation angle detected by the gyroscope 11 when the portable electronic device 1 is in the unlock mode).

The unlocking condition is when the screen 15 of the portable electronic device 1 is in a lock mode, and the detected rotation direction and the detected rotation angle of the portable electronic device 1 respectively match the predetermined rotation direction and the predetermined rotation angle stored in the storage unit 14.

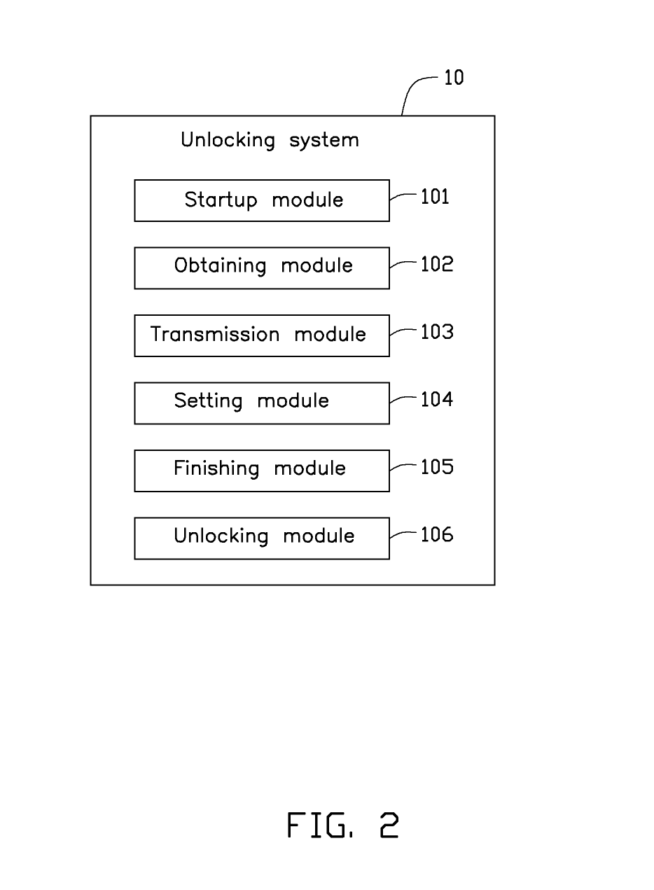

The unlocking system 10 may include one or more modules (shown in FIG. 2). The one or more modules may comprise computerized code in the form of one or more programs that are stored in the storage unit 14. In one embodiment, the storage unit 14 may be a magnetic storage system, an optical storage system, or other suitable storage medium. The computerized code includes instructions that are executed by the processor 14 to provide functions for the one or more modules described below.

As shown in FIG. 2, the unlocking system 10 includes a startup module 101, an obtaining module 102, a transmission module 103, a setting module 104, a finishing module 105, and an unlocking module 106.

The startup module 101 is operable to switch operation of the portable electronic device 1 from the work mode to the unlock mode. The gyroscope 11 detects the angular rotation of the portable electronic device 1. The data processing unit 12 converts the detected angular rotation into the rotating direction and the rotating angle.

The obtaining module 102 is operable to obtain the rotating direction and the rotating angle from the data processing unit 12.

In addition, the obtaining module 102 also sets a predetermined time period (such as 0.5 second or one second) to determine whether the rotation of the portable electronic device 1 is complete. For example, if the predetermined time period is two seconds, the obtaining module 102 obtains the rotating direction and the rotating angle of the portable electronic device 1 generated within two seconds.

The transmission module 103 is operable to transmit the rotation direction and the rotation angle of the portable electronic device 1 received from the obtaining module 102 to the processor 13. The processor 103 controls the screen 15 to display the rotation direction and the rotation angle.

The setting module 104 is operable to determine whether the portable electronic device 1 is unlocked for the first time. For example, if the storage unit 14 does not store any predetermined rotating direction and any predetermined rotating angle, the setting module 104 determines that the electronic device 1 was unlocked for the first time, and the setting module 104 directly stores the rotation direction and the rotation angle in the storage unit 14 to as the predetermined rotating direction and the predetermined rotating angle.

If the storage unit 14 stores the predetermined rotating direction and the rotating angle, the setting module 104 determines that the electronic device 1 was not unlocked for the first time so that the setting module 104 further determines whether the current detected rotating direction and the current detected rotating angle are the same as the predetermined rotating direction and the predetermined rotating angle. If the current detected rotating direction and the current detected rotating angle are the same as the predetermined rotating direction and the predetermined rotating angle, the setting module 104 maintains the predetermined rotating direction and the predetermined stored rotating angle in the storage unit 14. If the detected rotating direction and the detected rotating angle are not same as the predetermined rotating direction and the predetermined rotating angle, the setting module 104 stores the detected rotating direction and the detected rotating angle as a new predetermined rotating direction and a new predetermined rotating angle in the storage unit 14.

The finishing module 105 is operable to switch operation of the portable electronic device 1 from the unlock mode to the work mode.

The unlocking module 106 is operable to obtain the rotation direction and rotation angle when the portable electronic device 1 is in the lock mode and determines whether the rotation direction and the rotation angle are the same as the predetermined rotation direction and the predetermined rotation angle. If the rotation direction and the rotation angle are not the same as the predetermined rotation direction and the predetermined rotation angle, the unlocking module 106 determines that the portable electronic device 1 stays locked. If the rotation direction and the rotation angle are the same as the predetermined rotation direction and the predetermined rotation angle, the unlocking module 106 sends an unlock signal to the processor 13 and controls the processor 13 to unlock the portable electronic device 1.

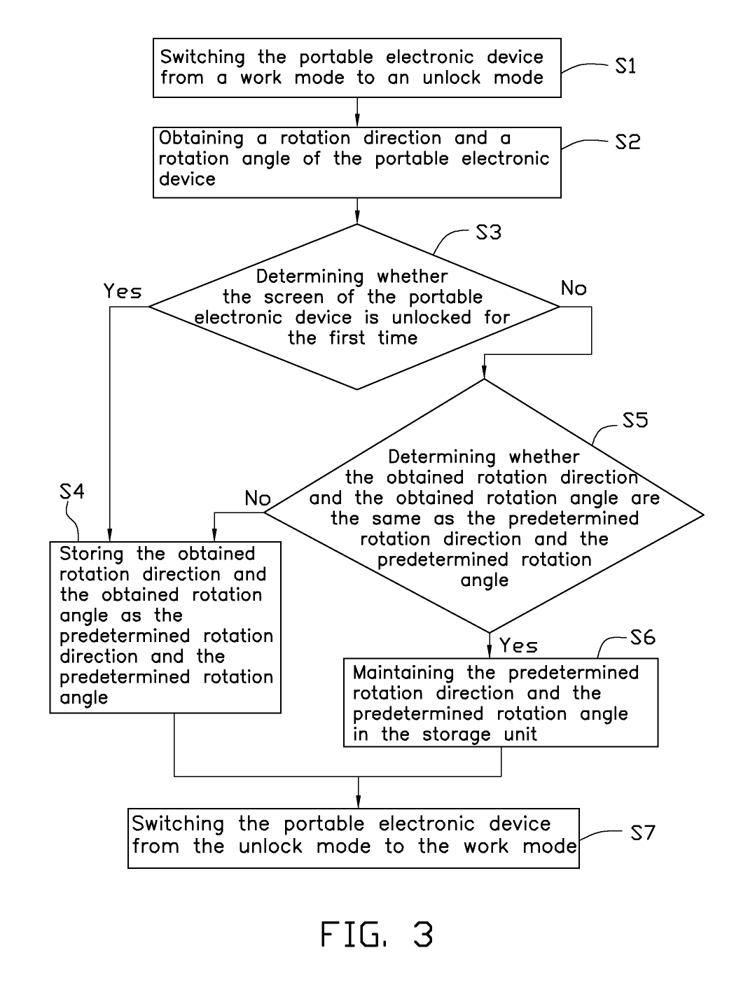

FIG. 3 is a flowchart of one embodiment of a method for setting an unlock method of a portable electronic device 1. Depending on the embodiment, additional steps may be added, others deleted, and the ordering of the steps may be changed.

In block S1, the startup module 101 switches the portable electronic device 1 from a work mode to an unlock mode. The gyroscope 11 detects the angular rotation of the portable electronic device 1. The signal processing unit 12 converts the detected angular rotation into the rotation direction and the rotation angle.

In block S2, the obtaining module 102 obtains the rotation direction and the rotation angle of the portable electronic device 1 detected by the gyroscope 11.

In block S3, the setting module 104 determines whether the screen 15 of the portable electronic device 1 is unlocked for the first time. An unlock method for unlocking the screen 15 of the portable electronic device 1 can comprise the rotation direction and the rotation angle of the portable electronic device 1. If the screen 15 of the electronic device 1 was unlocked for the first time, the process goes to block S4. If the screen 15 of the electronic device 1 was not unlocked for the first time, the process goes to block S5.

In block S4, the storage unit 14 stores the current detected rotation direction and the rotation angle as the predetermined rotation direction and the predetermined rotation angle.

In block S5, the setting module 104 further determines whether the obtained rotation direction and the rotation angle is the same as the predetermined rotation direction and the predetermined rotation angle. If the detected rotating direction and the detected rotating angle are not same as the predetermined rotating direction and the predetermined rotating angle, the process goes to block S4, that is the setting module 104 stores the detected rotating direction and the detected rotating angle as a new predetermined rotating direction and a new predetermined rotating angle in the storage unit 14. If the current detected rotating direction and the current detected rotating angle are same as the predetermined rotating direction and the predetermined rotating angle, the process goes to block S6.

In block S6, the setting module 14 maintains the predetermined rotation direction and the predetermined rotation angle in the storage unit 14, and the process goes to block S7.

In block S7, the finishing module switches the portable electronic device 1 from the unlock mode to the work mode. Thus, the unlock method is set for the portable electronic device 1.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A portable electronic device, comprising:
a storage unit;
a screen;
at least one processor;
a gyroscope detecting an angular rotation of the portable electronic device;
a data processing unit converting the angular rotation into a rotation direction and a rotation angle; and
one or more programs that are stored in the storage unit and are executed by the at least one processor, the one or more programs comprising:
a setting module determining whether the portable electronic device is unlocked for the first time when the screen of the portable electronic device is in an unlock mode;
if the screen of the electronic device was unlocked for the first time, the setting module setting the obtained rotating direction and rotating angle as a predetermined rotating direction and a predetermined rotating angle;
if the screen of the electronic device 1 was not unlocked for the first time, the setting module further determining whether the detected rotating direction and the current detected rotating angle are same as the predetermined rotating direction and the predetermined rotating angle, and setting a new predetermined rotating direction and a new predetermined rotating angle when the detected rotating direction and the current detected rotating angle are not same as the predetermined rotating direction and the predetermined rotating angle; and
an unlocking module controlling the least one processor to unlock the screen of the portable electronic device if the rotation direction and the rotation angle are the same as the predetermined rotation direction and the predetermined rotation angle, when the portable electronic device is in a lock mode.

2. The portable electronic device of claim 1, wherein if the current detected rotating direction and the current detected rotating angle are same as the predetermined rotating direction and the predetermined rotating angle, the setting module maintains the predetermined rotating direction and the predetermined stored rotating angle in the storage unit.

3. The portable electronic device of claim 1, wherein the one or more programs further comprises a startup module switching the portable electronic device from a work mode into the unlock mode.

4. The portable electronic device of claim 1, the one or more programs further comprising: a finishing module switching the portable electronic device from the unlock mode to the work mode.

5. The portable electronic device of claim 1, wherein the obtaining module sets a predetermined time period to determine whether the rotation of the portable electronic device is complete.

6. A computer-implemented method for unlocking a portable electronic device, the portable electronic device comprising a gyroscope, a storage unit, and a screen, the method comprising:
obtaining a rotation direction and a rotation angle of the portable electronic device detected from the gyroscope;
determining whether the screen of the portable electronic device is unlocked for the first time when the portable electronic device is in a unlock mode;
if the screen of electronic device was unlocked for the first time, the obtained rotating direction and rotating angle is set as a predetermined rotating direction and a predetermined rotating angle;
if the screen of electronic device was not unlocked for the first time, further determining whether the detected rotating direction and the current detected rotating angle are same as the predetermined rotating direction and the predetermined rotating angle, and setting a new predetermined rotating direction and a new predetermined rotating angle when the detected rotating direction and the current detected rotating angle are not same as the predetermined rotating direction and the predetermined rotating angle.

7. The method of claim 6, further comprising if the current detected rotating direction and the current detected rotating angle are same as the predetermined rotating direction and the predetermined rotating angle, maintaining the predetermined rotating direction and the predetermined stored rotating angle in the storage unit.

8. The method of claim 6, further comprising:
switching the portable electronic device from a work mode into the unlock mode before determining whether it is the first time to set the unlock method of the portable electronic device.

9. The method of claim 7, further comprising:
switching the portable electronic device from the unlock mode to the work mode after setting a new predetermined rotating direction and a predetermined rotating angle.

10. The method of claim 6, wherein setting a predetermined time period to determine whether the rotation of the portable electronic device is complete when obtaining a rotating direction and a rotating angle of the portable electronic device.

11. A storage medium having instructions stored thereon causing the processor to perform a method for unlocking a portable electronic device when executed by a processor, the method comprising:
obtaining a rotation direction and a rotation angle and an acceleration of the portable electronic device detected from a gyroscope;
determining whether the portable electronic device is unlocked for the first time when the screen of the portable electronic device is in a unlock mode;
if the screen of the electronic device was unlocked for the first time, the setting module setting the obtained rotating direction and rotating angle as the predetermined rotating direction and the predetermined rotating angle;
if the screen of the electronic device was not unlocked for the first time, the setting module further determining whether the detected rotating direction and the current detected rotating angle are same as the predetermined rotating direction and the predetermined rotating angle, and setting a new predetermined rotating direction and a new predetermined rotating angle when the detected rotating direction and the current detected rotating angle are not same as the predetermined rotating direction and the predetermined rotating angle.

12. The storage medium of claim 11, wherein if the current detected rotating direction and the current detected rotating angle are same as the predetermined rotating direction and the predetermined rotating angle, maintaining the predetermined rotating direction and the predetermined stored rotating angle in the storage unit.

13. The storage medium of claim 11, further comprising:
switching the portable electronic device from a work mode into the unlock mode before determining whether it is the first time to set the unlock method of the portable electronic device.

14. The storage medium of claim 11, further comprising:
switching the portable electronic device from the unlock mode to the work mode after setting a new predetermined rotating direction and a predetermined rotating angle according to the determining result.

15. The storage medium of claim 11, further comprising:
setting a predetermined time period to determine whether the rotation of the portable electronic device is complete when obtaining a rotating direction and a rotating angle of the portable electronic device.
